(19) United States
(12) Patent Application Publication
(10) Pub. No.: US 2024/0238819 A1
(43) Pub. Date: Jul. 18, 2024

(54) DISPENSING APPARATUS

(71) Applicant: APTAR DORTMUND GMBH, Dortmund (DE)

(72) Inventors: Ralf JORDAN, Dortmund (DE); Börje HEGENBERG, Dortmund (DE); Lukas KUROSKY, Dortmund (DE)

(21) Appl. No.: 18/561,982

(22) PCT Filed: May 19, 2022
(86) PCT No.: PCT/EP2022/063641

§ 371 Date: Nov. 17, 2023

(30) Foreign Application Priority Data
May 20, 2021 (DE) 10 2021 002 634.9
Sep. 2, 2021 (DE) 10 2021 122 705.4
Jan. 24, 2022 (EP) 22152969.6
Mar. 7, 2022 (EP) 22160513.2

(51) Int. Cl. B05B 11/10

(52) U.S. Cl. CPC B05B 11/1077; B05B 11/1001

(57) ABSTRACT

A spring made of plastic, a dispensing apparatus provided therewith for in particular cosmetic products and the use of such a spring are proposed, wherein the spring is made of a material mixture with propylene and has special characteristic values for achieving good spring properties.

### CROSS-REFERENCE TO RELATED APPLICATIONS

The present application is a national stage application under 35 U.S.C. 371 of PCT Application No. PCT/EP2022/063641, filed 19 May 2022, which designated the United States, which PCT application claimed the benefit of German Patent Application No. 10 2021 002 634.9, filed 20 May 2021, German Patent Application No. 10 2021 122 705.4, filed 2 Sep. 2021, European Patent Application No. 22152969.6, filed 24 Jan. 2022, and European Patent Application No. 22160513.2, filed 7 Mar. 2022, each of which are incorporated herein by reference in their entirety.

### BACKGROUND

The present invention relates to a dispensing apparatus.

In the present invention, the term “dispensing apparatus” is preferably understood to mean an apparatus for in particular spraying dispensing a preferably liquid product, particularly preferably as an aerosol, which is preferably actuatable by hand.

Preferably, a pump or dispensing apparatus in the sense of the present invention has at least one functional spring associated, for example, with a pump piston and/or a valve. Up to now, metal springs have been primarily used. Plastic springs, which are increasingly being provided as an alternative to metal springs, mostly do not have good or satisfactory spring properties.

WO 2004/065095 A1 discloses a screw compression spring made of plastic embodied as an injection molded part, in which winding sections adjoining a parting plane have a smaller incline on at least one side than the winding pitches. Due to the inhomogeneous incline of the windings, the spring characteristic is not linear, so that the spring does not exhibit optimum spring properties. The plastic is not specified further.

EP 1 506 818 B2 discloses an accumulator-type liquid sprayer comprising two elastic members, the first elastic member returning a pump piston and the second elastic member forming an element of an outlet valve. The materials of the injection molded elastic members and the components of the accumulator-type liquid sprayer may be polyethylene, polypropylene, nylon, acrylonitrile butadiene styrene, polyethylene terephthalate, polybutylene terephthalate or polyoxymethylene.

WO 2009/094793 A1 discloses a plastic spring which can be used, among other things, in devices for cosmetic applications. The plastic spring is preferably injection molded from a thermoplastic plastic. The spring may be made exclusively of a plastic that is not further specified, but alternatively, for example, reinforcing fibers or other elements may be embedded in the plastic. The plastic is not specified further.

DE 44 41 263 A1 discloses a dispenser with a working member that has a spring section that can be designed as a helical or torsion spring having a closed spring jacket. The dispenser or the respective working member is manufactured as an injection-molded part from plastics, which can be copolymers such as polyethylene, polypropylene or other thermoplastics.

FR 2 969 241 discloses a plastic spring consisting of rings and elastic elements. During compression, torsions occur in each spring plane, which are macroscopically averaged out so that the spring as a whole can be compressed without torsion. The rings of the spring are made of a rigid plastic, and the elastic elements of the spring are made of a soft plastic. The plastic is not specified further.

US 2003/0209567 A1 discloses an assembly for atomizing a product. The assembly has exactly one spring made of plastic. Several embodiments of the spring are described. The spring is preferably made of polyoxymethylene, polyethylene or polypropylene.

EP 1 375 011 B1 discloses a metering device with a bellows spring made of plastic, the bellows spring being formed integrally with an outlet valve. The plastic is not specified further.

U.S. Pat. No. 10,543,500 B2 discloses a fluid pump with a spring, wherein styrenic block copolymers, polyolefins, elastomeric alloys, thermoplastic polyurethanes, thermoplastic copolyesters and thermoplastic polyamides are suitable materials for the spring. In the case of polyolefins, a mixture of at least two different polyolefins and/or a copolymer of at least two different monomers may be used. In one embodiment, plastomers from the group of thermoplastic polyolefin mixtures are used, for example from the group of polyolefin copolymers. Also suitable is the group of ethylene alpha olefin copolymers. Among these, ethylene 1-octene copolymers have been shown to be particularly suitable.

DE 44 11 031 A1 discloses a hand lever-operated pump for dispensing liquid or paste-like media. A return spring of a hand lever of the pump is designed as a bellows spring, which is manufactured by injection molding and consists of plastic, for example polypropylene or polyethylene.

DE 694 26 626 T2 discloses a pumping device with a collapsible pump chamber. The pump chamber is a bellows having a modulus of elasticity below 10,000 psi. Exemplary materials disclosed are polyolefins such as polypropylene, low-density polyethylene, very low-density polyethylene, and ethylene vinyl acetate.

DE 43 90 813 T1 discloses a hand sprayer having a body and a pump mechanism with a trigger movably mounted on the body. A plastic spring assembly is placed between the body and the trigger to always return the trigger to an initial position. The spring assembly contains two leaf springs connected at their ends by ribs. The leaf springs are made of glass fiber reinforced plastic material, such as a mixture of polypropylene and polyamide (nylon)+30% by weight glass fiber.

WO 2020/156 935 A1 discloses a dispenser for dispensing flowable, for example liquid or pasty, masses. The dispenser has a return device in the form of a plastic spring with a lower spring ring and an upper spring ring, which are compressibly connected to one another other by spring struts. Polypropylene with fillers can be used as the plastic for the spring.

U.S. Pat. No. 10,543,500 B2 discloses a fluid pump with a plastomer spring. The spring has several rhombus-shaped resilient sections.

The known plastic springs are not optimal for dispensing apparatuses that should be easy to operate manually and have a long service life.

### SUMMARY

The object underlying the invention is to provide a spring made of plastic, in particular for a dispensing apparatus, a dispensing apparatus with a spring made of plastic and a use of a spring made of plastic, wherein the spring has a largely linear force-displacement diagram, is easy to actuate and/or is largely fatigue-resistant and/or hysteresis-free, enables easy and/or complete recycling and/or is conducive to a simple and inexpensive design.

The above object is solved by dispensing device as disclosed herein.

A first aspect of the present invention is that the spring is preferably reversibly compressible by at least 10% and/or the modulus of elasticity of the plastic is less than 1500 MPa. Experiments have shown that such a spring exhibits good spring properties and, in particular, is easy and pleasant to operate, especially when the spring is compressed by a maximum of 20 or 30% starting from the relaxed state.

Surprisingly, experiments have additionally shown that a reduction in the modulus of elasticity of the spring material of a spring is accompanied by greater reversible compression.

A second aspect of the present invention, which can also be implemented independently, is that the spring is preferably configured such that, at least up to a compression of 10%, the characteristic value K1 is less than 0.05 [N/mm^{2.5}], where K1=(W·L^{0.5})/(V·S²), where W is the work to compress the spring from the relaxed state by the path S, and Vis the plastic volume of the resilient section. Experiments have shown that a plastic spring configured in this way exhibits good spring properties and in particular very good fatigue resistance.

A third aspect of the present invention, which can also be implemented independently, is that the spring is configured such that, at least up to a compression of 10%, the characteristic value K2 is less than 0.005 [mm^{-3.5}], where K2=(W·L^{0.5}·RA)/(V·AF·E·S²), where W is the work to compress the spring from the relaxed state by the path S, RA is the outer diameter of the resilient section, AF is the filling factor of the relaxed resilient section, E is the modulus of elasticity of the material of the resilient section, and V is the plastic volume of the resilient section. Namely, experiments have confirmed that a plastic spring configured in this way exhibits good spring properties and in particular is at least largely hysteresis-free.

A fourth aspect of the present invention, which can also be implemented independently, is that the plastic of the spring and/or of the resilient section is preferably a material mixture with polypropylene as the basic component and at least one additional component, at least 50% by weight and at most 95% by weight of the material mixture being formed from the basic component.

The basic component alone is unsuitable as a spring material because the spring is then not sufficiently reversibly compressible, in particular only up to about 5%. This is due to the structure of the basic component, which, figuratively speaking, consists of threads interlinked in all three dimensions. With the addition of the additional component, the threads are only linked in two dimensions, i.e. in planes, which means that the planes can be reversibly shifted relative to each other to a limited extent. Above a certain threshold value of the proportion of the additional component, the spring is very compressible without breaking, but does not subsequently return to its original shape because the material flows, i.e. is too easily plastically deformed. The optimum material mixtures—in particular for a preferred spring shape—were determined by experiments.

A fifth aspect of the present invention, which can also be implemented independently, is that the plastic is a material mixture with polypropylene as the basic component and at least one additional component, wherein the density of the plastic is equal to or less than 0.9 g/cm³ and/or the density of the additional component is less than the density of the basic component. Very good elastic properties can thus be achieved, as experiments have shown.

Preferably, the additional component has polyethylene, ethylene-octene copolymers and/or isotactic propylene repeating units with random ethylene distribution. These materials are particularly well suited as additional components, since they are excellently miscible with the basic component and lead to good elastic properties, as experiments have shown.

Preferably, the modulus of elasticity of the additional component is less than 1,000 MPa and/or the modulus of elasticity of the basic component is greater than 1,000 MPa. Thus, the modulus of elasticity of the material mixture can be adjusted very well, by the ratio of the components to each other, although experiments have shown that the modulus of elasticity of the material mixture does not depend linearly on the proportion of the additional component.

Preferably, a spring according to the invention is produced by injection molding. In this way, the spring can be produced very inexpensively and in very large quantities.

Preferably, the spring shape is designed in such a way that it does not form any undercuts on the injection mold side during its manufacture. Preferably, this allows the spring to be easily removed from the injection molds, in particular non-destructively.

A spring according to the invention preferably forms a valve element of an inlet valve and/or outlet valve. This is conducive to a compact and simple design, in particular of a pump or dispensing apparatus.

A sixth aspect of the present invention, which can also be implemented independently, relates to an, in particular manually actuatable, dispensing apparatus, which has at least one spring made of plastic according to the invention, in particular according to one of the aforementioned aspects, for example for returning a pump piston and/or an inlet valve or outlet valve. Thus, in particular, a very good user-friendliness and/or easy operability with a long service life and/or a complete recyclability of the dispensing apparatus can be achieved.

A seventh aspect of the present invention, which can also be implemented independently, relates to an, in particular manually actuatable, dispensing apparatus, which has at least one spring made of plastic, for example for returning a pump piston, wherein the difference between the restoring force of the spring in a maximally compressed state and the restoring force of the spring in a minimally compressed state is less than 20 N, preferably less than 15 N, particularly preferably less than 10 N. In this way, it can be achieved that the force required to actuate the dispensing apparatus increases only slightly during actuation. This is conducive to a high degree of user-friendliness.

An eighth, also independently realizable aspect of the present invention relates to an, in particular manually actuatable, dispensing apparatus which has at least one spring made of plastic, for example for returning a pump piston and/or as a valve element of an inlet valve or outlet valve, wherein the spring in a minimally compressed state in the dispensing apparatus is pretensioned or compressed by at least 5%, in particular 10%, and this spring in a maximally compressed state in the dispensing apparatus is compressed by less than 30%, in particular less than 25%, particularly preferably less than 20%. Experiments have shown that the spring exhibits high stability in this range in particular.

In particular, the provided limitation of the maximum compression of the spring in the final state prevents plastic deformation of the spring. Thus, the minimum and maximum compression of the spring can increase the service life of the dispensing apparatus.

Preferably, the spring is minimally pretensioned and/or compressed in the initial state of the dispensing apparatus and/or maximally compressed in the final state of the dispensing apparatus. In this way, a simple and compact design of the dispensing apparatus can be achieved.

A ninth aspect of the present invention, which can also be implemented independently, relates to a use of a spring according to the invention as a return element of a pump piston and/or an inlet valve or outlet valve, in particular of a preferably manually actuatable dispensing apparatus, for dispensing a preferably cosmetic fluid or product. Thus, corresponding advantages result.

In particular, the plastic spring according to the invention solves or reduces the problem of an undesired rapid fatigue, an undesired and/or strong hysteresis and/or an undesired and/or strong deviation from a linear spring characteristic in other plastic springs.

In addition, the spring according to the invention enables a simple, stable, compact and/or cost-effective design of a dispensing apparatus and/or pump according to the invention and/or supports a hygienic conveyance and/or dispensing of the product into/from a dispensing apparatus and/or pump according to the invention and/or the complete and/or simple recyclability of the dispensing apparatus and/or pump.

The above-mentioned aspects and features of the present invention, as well as the aspects and features of the present invention resulting from the claims and the following description, can in principle be realized independently of each other, but also in any combination.

Further aspects, advantages, features and characteristics of the present invention will be apparent from the claims and the following description of preferred embodiments with reference to the drawings.

### BRIEF DESCRIPTION OF THE DRAWINGS

FIG. 1 is a schematic section of a proposed pump or dispensing apparatus with a proposed spring made of plastic as the main spring and a proposed spring according to the proposal as the outlet spring according to a first embodiment;

FIG. 2 is a schematic view of the main spring according to the first embodiment;

FIG. 3 is a schematic longitudinal section of the spring according to FIG. 2;

FIG. 4 is a schematic view of the proposed main spring according to a second embodiment;

FIG. 5 is a schematic longitudinal section of the spring according to FIG. 4;

FIG. 6 is a schematic view of the proposed main spring according to a third embodiment;

FIG. 7 is a schematic front view of the spring according to FIG. 6;

FIG. 8 is a schematic longitudinal section of the spring according to FIG. 6;

FIG. 9 is an enlarged view of the dash-dotted area of FIG. 6;

FIG. 10 is a schematic view of the proposed main spring according to a fourth embodiment;

FIG. 11 is a schematic front view of the spring according to FIG. 10;

FIG. 12 is an enlarged view of the dash-dotted area of FIG. 10;

FIG. 13 is a schematic view of the proposed main spring according to a fifth embodiment;

FIG. 14 is a schematic longitudinal section of the spring according to FIG. 13;

FIG. 15 is an enlarged view of the dash-dotted area of FIG. 13;

FIG. 16 is a schematic view of the proposed main spring according to a sixth embodiment;

FIG. 17 is a schematic longitudinal section of the spring according to FIG. 16;

FIG. 18 is a schematic view of the proposed outlet spring according to the first embodiment;

FIG. 19 is a schematic front view of the spring according to FIG. 18;

FIG. 20 is a schematic longitudinal section of the spring according to FIG. 18;

FIG. 21 is a first diagram;

FIG. 22 is a second diagram;

FIG. 23 is a schematic view of the proposed outlet spring according to a second embodiment; and

FIG. 24 is a schematic section of the proposed outlet spring according to the second embodiment.

### DETAILED DESCRIPTION

In the figures, some of which are not to scale and are merely schematic, the same reference signs are used for the same, kindred or similar parts and components, with corresponding or comparable properties and advantages being achieved, even if a repeated description is omitted.

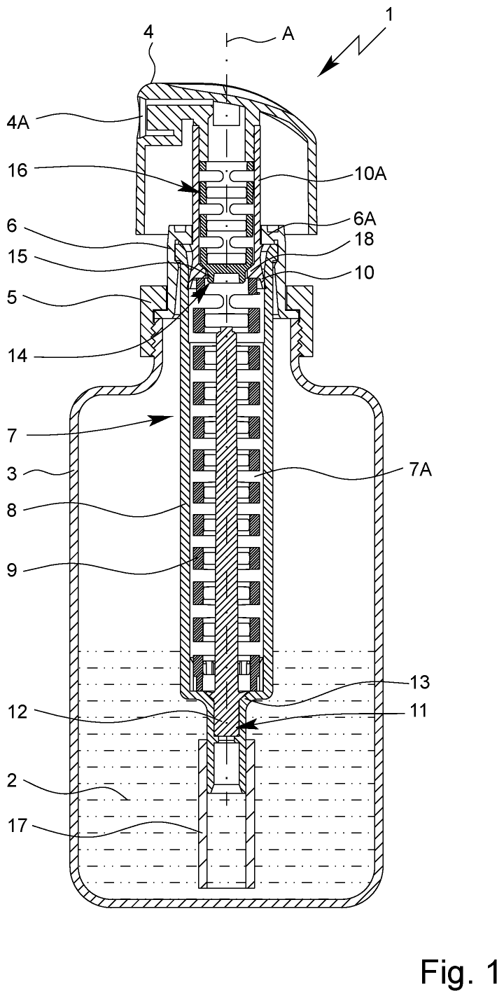

FIG. 1 shows a schematic longitudinal section of a dispensing apparatus 1 or pump 7 according to the proposal with one or two springs 9, 16 according to the proposal.

The dispensing apparatus 1 or pump 7 is preferably used for dispensing a, preferably fluid or liquid product 2, in particular as a spray jet, spray mist and/or aerosol.

Particularly preferably, the fluid or product 2 serves cosmetic purposes or beauty care. For example, it is a hair spray, hair foam, sunscreen or the like.

However, the dispensing apparatus 1 or pump 7 can also be used for cleaning agents, household products or other products 2.

Preferably, the dispensing apparatus 1 comprises a container 3 for the product 2, a dispensing head 4, a connecting part 5, a housing part 6 and/or the pump 7.

The dispensing apparatus 1 and/or pump 7 is preferably designed to draw or convey the product 2, in particular a predefined volume of the product 2, from the container 3, to pressurize it and/or to dispense it under pressure.

Preferably, the fluid or product 2 can be dispensed via the dispensing head 4 or a nozzle 4A of the dispensing head 4 and/or dispensing apparatus 1.

The dispensing apparatus 1 and/or pump 7 is preferably attached to and/or connected with the container 3, e.g. snapped on or screwed on, by means of the connecting part 5 and/or housing part 6. In the embodiment shown, the dispensing head 4 and/or the housing part 6 is preferably connected or connectable to the container 3 by means of the connecting part 5, preferably in a form-fitting, force-fitting and/or material-bonding manner, in particular by screwing. However, solutions are also possible in which the dispensing head 4 or the housing part 6 has or forms the connecting part 5 and/or the dispensing head 4 is directly connected or connectable to the container 3.

In particular, the connecting part 5 and/or housing part 6 holds the pump 7 or its pump housing 8 on the outlet side.

In the illustrative example, the housing part 6 is fixedly connected or latched to the pump housing 8 or forms part of the pump housing 8.

The pump 7 is preferably arranged at least partially or completely inside the container 3.

Preferably, the dispensing apparatus 1 and/or pump 7 has a pump housing 8, the spring 9 according to the proposal in the form of a main spring, a pump piston 10, an inlet valve 11, an outlet valve 14 and/or the (further) spring 16 according to the proposal in the form of a valve or outlet spring.

Preferably, the dispensing apparatus 1 or pump 7 has a riser 17 connected in particular to one end or inlet of the pump 7, preferably to receive or draw the product 2 from the container 3.

The inlet valve 11 preferably has an inlet valve body 12 and an inlet valve seat 13.

Preferably, the outlet valve 14 has the outlet spring 16 and/or an outlet valve body 15 and an outlet valve seat 18, in particular wherein the outlet valve spring 16 is integrally formed with the outlet valve body 15 and/or presses and/or biases the outlet valve body 15 against the outlet valve seat 18 into the closed position and/or closes the outlet valve 14.

In particular, the outlet valve 14 is arranged on or in the pump piston 10.

Preferably, the pump piston 10, in particular a piston shaft or hollow section 10A of the pump piston 10, projects axially out of the pump housing 8 or housing part 6 and/or towards the dispensing head 4. Particularly preferably, the housing part 6 or pump housing 8 has an (axial) opening through which the piston 10 or section 10A extends outwardly and/or toward the dispensing head 4.

Preferably, the housing part 6 or pump housing 8 has an axial stop 6A for the pump piston 10.

Preferably, the pump 7 or the outlet valve 14 or the pump piston 10 has an outlet, in particular wherein the outlet is fluidically connected to the dispensing head 4.

The dispensing head 4 is preferably firmly and/or fluidically connected to the piston 10, in particular via the shaft or section 10A.

Preferably, the outlet valve 14 and/or the outlet valve body 15 and/or the outlet spring 16 is/are arranged within the pump piston 10 and/or section 10A and/or in the dispensing head 4 and/or between the pump piston 10 and dispensing head 4. In particular, the outlet spring 16 is abutted at one end to the dispensing head 4 and/or at its other, opposite end to the pump piston 10.

In particular, the outlet spring 16 is installed in a pretensioned manner.

Preferably, the pump housing 8, the inlet valve 11 and the outlet valve 14 or the pump piston 10 form and/or delimit a pump chamber 7A of the pump 7.

Preferably, the main spring 9 is arranged within the pump chamber 7A and/or within the pump housing 8.

Preferably, the main spring 9 is abutted at one end to the pump piston 10 and/or its other, opposite end to the pump housing 8 or inlet valve body 12.

In particular, the pump piston 10 is pressed or pretensioned into a closed or initial state by the main spring 9.

In particular, the main spring 9 is installed pretensioned.

Preferably, the dispensing apparatus 1 and/or pump 7 and/or pump housing 8 has or have a longitudinal axis A.

Preferably, the fluid/product 2 can flow through the pump 7 and/or pump chamber 7A axially or along the longitudinal axis A and/or from the inlet to the outlet.

Preferably, the pump housing 8, the inlet valve 11, the outlet valve 14 and/or the pump piston 10, the main spring 9 and/or the outlet spring 16, particularly preferably all parts or components of the dispensing apparatus 1 and/or pump 7, are/is made of plastic and/or injection molded.

Preferably, the pump 7 is designed as a positive displacement pump, in particular a metering pump or reciprocating pump.

By actuating the dispensing apparatus 1 and/or pressing down the dispensing head 4 and/or a movement of the pump piston 10 downwards or towards the container 3, the pressure in the pump chamber 7A, in which there is preferably a predefined volume of the product 2, is preferably increased, the volume of the pump chamber 7A is reduced, the main spring 9 is compressed and/or the dispensing apparatus 1 is transferred to the final state.

Particularly preferably, the outlet valve 14 opens (automatically) when a certain pressure in the pump chamber 7A is exceeded and/or the volume of the pump chamber 7A is reduced by means of the pump piston 10, in particular by compressing the outlet spring 16. Thus, when a certain pressure (opening pressure) is exceeded, the product 2 is dispensed from the pump chamber 7A via the outlet to the dispensing head 4 and optionally sprayed or otherwise dispensed—in particular by means of the nozzle 4A.

After the product 2 has been dispensed and/or the pump actuation or movement has ended and/or the depressed final state has been reached, the pressure is reduced and the outlet valve 14 closes again automatically.

After completion of the depressing of the dispensing head 4, the pump piston 10 and/or the dispensing head 4 is preferably returned or moved to the initial state by the restoring force and/or decompression of the main spring 9. Preferably, this further reduces the pressure in the pump chamber 7A and/or creates a negative pressure so that the inlet valve 11 is opened and the product 2 is drawn from the container 3 via the inlet into the pump chamber 7A.

Preferably, the inlet valve 11 closes again automatically after pressure equalization and/or during the next actuation (depressing the piston 10) due to the pressure increase.

Preferably, the inlet valve body 12 of the inlet valve 11 is formed as a long rod and/or extends along the longitudinal axis A.

Preferably, the inlet valve body 12 is designed or dimensioned in such a way that—shortly before the pump piston 10 reaches its depressed end position—it can open the outlet valve 14 and/or lift the outlet valve body 15 off the outlet valve seat 18. This is important in particular during the first use, in order to be able to discharge air from the pump chamber 7A during so-called priming and to fill the pump chamber 7A with fluid/product 2.

The initial state of the dispensing apparatus 1 and/or pump 7 shown in FIG. 1 is preferably the state that the pump 7, in particular the pump piston 10 and/or dispensing head 4, assumes in the unactuated state and/or automatically or by the spring force of the main spring 9. In the initial state, the volume of the pump chamber 7A is at a maximum and/or the main spring 9 is decompressed (but pretensioned) and/or the pump piston 10 and/or dispensing head 4 is in its upper end position or rest position.

The final state of the dispensing apparatus 1 and/or of the pump 7 is preferably the state that the pump 7, in particular the pump piston 10 and/or the dispensing head 4, assumes when the volume of the pump chamber 7A is minimal and the outlet valve 14 is open.

In the final state (actuated or depressed state), the pump piston 10 assumes its lower end position in the representation according to FIG. 1 and the dispensing head 4 is in its depressed end position.

In the final state, the outlet valve 14 is preferably compulsorily opened by the inlet valve body 12.

The final state is preferably limited mechanically, for example by stopping the dispensing head 4 on the container 3, connecting part 5 or housing part 6 or in some other way.

Alternatively or additionally, the inlet valve body 12 can also form an end stop for the pump piston 10.

In the illustration example, the inlet valve body 12, outlet valve body 15 and/or outlet spring 16, preferably hit the outlet valve body 15 and/or outlet spring 16 shortly before reaching the final state, so that the outlet spring 16 acts in a damping or braking manner with in particular increasing force until the pump piston 10 and dispensing head 4 actually reach the final position or final state.

In the following, preferred aspects and features of the spring 9 and/or 16 according to the proposal are explained in more detail on the basis of the further figures, wherein the explanations for the main spring 9 also apply correspondingly or supplementarily to the outlet spring 16 and vice versa, without the need for repetition.

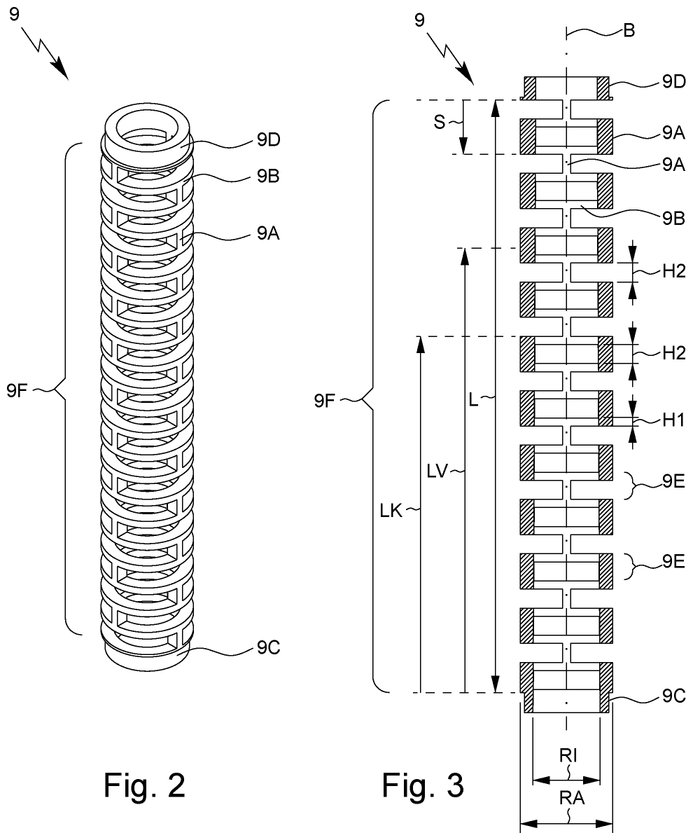

FIG. 2 shows a perspective view of the first embodiment of the main spring 9 according to the proposal, which is also shown in the illustration example according to FIG. 1. FIG. 3 shows this main spring 9 in a longitudinal section.

FIGS. 2 and 3 show the main spring 9 in the non-tensioned, i.e. relaxed and/or non-installed, state.

Preferably, the main spring 9 has a (central) spring axis B. In particular, when the main spring 9 is installed, the spring axis B runs along or coaxially with the longitudinal axis A of the dispensing apparatus 1 and/or pump 7.

The main spring 9 has a resilient section 9F, which is preferably at least substantially or exclusively responsible for the resilient properties of the main spring 9.

Preferably, the main spring 9 has a first or, in this case, lower end section/carrier 9C and/or an upper end section/carrier 9D.

Preferably, the lower carrier 9C and/or the upper carrier 9D form an axial end or ends of the main spring 9.

Preferably, the main spring 9 or the resilient section 9F has one or more windings or webs 9B extending preferably at least substantially in the circumferential direction and/or one or more supports 9A extending preferably at least substantially axially.

Preferably, the main spring 9 and/or the resilient section 9F is at least substantially hollow cylindrical.

Particularly preferably, the webs 9B and supports 9A form a hollow cylindrical section 9F of the main spring 9 and/or the resilient section 9F with radial openings.

The resilient section 9F has a plastic volume V which, due to the openings, is less than the volume of the corresponding hollow cylinder without openings, undercuts and the like.

It should be noted that the main spring 9 or the resilient section 9F may also have a shape that deviates from a hollow cylinder shape, for example by having an increasing and/or decreasing inner diameter and/or outer diameter. Here, the plastic volume V of the resilient section 9F is then determined accordingly from the material volume actually used to form the resilient section 9F.

The plastic volume V is always determined in the non-installed state, i.e. relaxed state, of the main spring 9.

Preferably, the axial height H2 of a support 9A is the minimum axial distance between two adjacent webs 9B in the area where the support 9A connects the webs 9B.

Preferably, the axial height H1 of a web 9B is defined by the axial distance between the axially lowest point of a web 9B and the axially highest point of this web 9B.

Preferably, the axial thickness of a web 9B is defined by the axial distance at an infinitesimal circumferential direction portion of the web 9B between the axially lowest point of said circumferential direction portion of the web 9B and the axially highest point of said circumferential direction portion of the web 9B.

Preferably, the axial thickness of a web 9B is constant or changes in the circumferential direction. In particular, the axial thickness of a web 9B in the circumferential direction is constant in a main spring 9 of the first embodiment.

Preferably, the axial thickness of a support 9A is defined by the axial distance at an infinitesimal circumferential direction portion of the support 9A between the axially lowest point of this circumferential direction portion of the support 9A and the axially highest point of this circumferential direction portion of the support 9A.

Preferably, the axial thickness of a support 9A is constant or changes in the circumferential direction. In particular, the axial thickness of a support 9A in the circumferential direction is constant in a main spring 9 of the first embodiment.

Preferably, the height H2 is greater than the height H1, in particular the ratio of the axial height H2 to the axial height H1 is greater than 1.2.

Preferably, the cross-section of a web 9B is at least substantially rectangular.

Preferably, the cross-section of a support 9A is at least substantially rectangular.

A cross-section of a web 9B, a support 9A or a spring 9, 16 is preferably understood as a section whose sectional plane is perpendicular to the main extension plane of this web 9B, this support 9A or this spring 9, 16.

Preferably, the lower carrier 9C and/or the upper carrier 9D exhibit at least substantially no resilient effect in the axial direction, and/or these form stiff and/or hollow cylindrical and/or annular bearing sections.

Preferably, the resilient section 9F adjoins the first and/or second carrier 9C, 9D with one or more axially aligned supports 9A, in particular with two supports 9A each on opposite sides, i.e. offset by 180°.

Preferably, a web 9B and/or a plurality of webs 9B, in particular a web 9B that revolves through 360° and/or is annular in the first embodiment and two supports 9A, form a spring layer 9E.

Preferably, the resilient section 9F is made up of several, repeating and in particular identical spring layers 9E, wherein an incomplete spring layer 9E can also occur or be provided at a transition to the carrier 9C and/or 9D—for example by omitting a web 9B.

In the first embodiment, the web 9B, which revolves through 360°, i.e. forms a closed ring, can also be conceived or formed as a plurality of web segments or webs 9B, in this case two or four web segments or webs 9B, extending from one support 9A to the next support 9A of the same spring layer 9E or both spring layers 9E.

Preferably, the axial height and/or thickness of a spring layer 9E is given by the sum of the height H1 and the height H2.

Preferably, the axial height of a spring layer 9E, the relaxed main spring 9, is greater than 1 mm, preferably greater than 2 mm, and/or less than 12 mm, preferably less than 9 mm.

Preferably, the supports 9A of a spring layer 9E are arranged rotationally symmetrically with respect to the spring axis B, preferably wherein the order of the rotational symmetry corresponds to the number of supports 9A and is 2 in the first embodiment example.

Preferably, each complete spring layer 9E comprises a complete web 9B of multiple web segments and one or more supports 9A.

In particular, a web 9B is complete if it extends 360° around the spring axis B and optionally merges into itself after one complete revolution around the spring axis B.

Preferably, the supports 9A of a spring layer 9E are evenly distributed in the circumferential direction around the spring axis B.

Preferably, the supports 9A of a spring layer 9E are identical.

Preferably, a web 9B is arranged below and/or above the supports 9A (in each case).

Preferably, the portion of a web 9B extending from one support 9A to the closest support 9A is referred to as a web segment.

Preferably, the number of web segments of a web 9B of a spring layer 9E is identical to the number of supports 9A of a spring layer 9E.

Preferably, the supports 9A of a relaxed main spring 9 extend parallel to the spring axis B or in the axial direction. Alternatively, the supports 9A may be inclined in the circumferential direction. In particular, the supports 9A may be inclined toward or away from the spring axis B. In addition, the supports 9A may be bent so that the axial slope of a support 9A may change in the circumferential direction, in particular several times. Furthermore, a support 9A can be curved.

A curvature preferably denotes that the cross-sectional area changes in axial direction and/or circumferential direction, in particular several times.

In particular, the supports 9A of a relaxed main spring 9 of the first embodiment extend parallel to the spring axis B or in the axial direction.

Preferably, the webs 9B of a relaxed main spring 9 extend parallel to a radial plane of the main spring 9, which is in particular perpendicular to the spring axis B. Alternatively, the webs 9B may be inclined in the circumferential direction, in particular such that the main extension plane of the web 9B is tilted with respect to a radial plane of the main spring 9. In addition, the webs 9B may be bent so that the axial slope of a web 9B may change in the circumferential direction, in particular several times. Furthermore, a web 9B may be curved.

In particular, the webs 9B of a relaxed main spring 9 of the first embodiment extend parallel to a radial plane of the main spring 9, which is in particular perpendicular to the axis B of the spring.

Preferably, a support 9A assumes a width in the circumferential direction about the spring axis B and/or a radial width perpendicular to this width and perpendicular to the axial thickness. Preferably, the width and/or the radial width of a support 9A changes axially. Preferably, a support 9A has a minimum width and/or radial width, and/or a maximum width and/or radial width.

In particular, the width and/or the radial width of a support 9A of a relaxed main spring 9 of the first embodiment is axially constant.

Preferably, the width and/or radial width of a support 9A is greater than 0.5 mm, preferably greater than 1 mm, and/or less than 8 mm, preferably less than 5 mm.

The number of supports 9A of a spring layer 9E is not limited to two. For example, a spring layer 9E can also have only one support 9A and/or three supports 9A and/or four supports 9A and/or five supports 9A and/or any number of supports 9A.

The number of spring layers 9E of the main spring 9 is preferably greater than 3, preferably greater than 5, and/or less than 20, preferably less than 15.

Preferably, the supports 9A of one or each spring layer 9E are arranged equidistantly distributed around the spring axis B, or the supports 9A of a spring layer 9E are spaced at different intervals radially around the spring axis B.

Preferably, all spring layers 9E have the same number of supports 9A.

Preferably, the supports 9A of two adjacent spring layers 9E are rotated or offset relative to each other about the spring axis B, preferably rotated or offset relative to each other by 45°, in particular by 60°, especially preferably by 90°. Preferably, the offset angle is the quotient of 180° and the number of supports 9A of a spring layer 9E.

Preferably, the periodicity of the stacking order of the spring layers 9E is two. Consequently, for example, the first, third and fifth spring layers 9E are identical to each other and/or the second, fourth and sixth spring layers 9E are identical to each other with respect to their rotational position.

Optionally, the stacking order of the spring layers 9E can also have a greater periodicity, preferably wherein several identical spring layers 9E, which are axially twisted relative to one another, are arranged adjacent to one another and/or different spring layers 9E are arranged adjacent to one another and/or a combination of the previously mentioned variants is realized.

Periodicity of stacking order of spring layers 9E generally refers in the present invention to the number of spring layers 9E adjacent to one another until the stacking order merges back into itself, for example, the periodicity of the stacking order ABABAB is two and the periodicity of the stacking order ABCCABABCCAB is six, where one letter represents one spring layer 9E.

Preferably, the total number of webs 9B of the spring 9 is an odd number.

Preferably, the supports 9A arranged on the lower carrier 9C are axially rotated relative to the supports 9A arranged on the upper carrier 9D.

Preferably, the main spring 9 and/or the resilient section 9F is hollow and/or at least substantially hollow cylindrical.

Preferably, the ratio of an outer diameter RA of the resilient section 9F to an inner diameter RI of the resilient section 9F, is greater than 1.05, preferably wherein the related outer diameter RA and inner diameter RI are at an axial height of the resilient section 9F.

Preferably, the ratio of the length L of the resilient section 9F to the outer diameter RA of the resilient section 9F is greater than 1.2.

Preferably, the main spring 9 is compressible along its spring axis B.

Preferably, the supports 9A remain at least substantially parallel to the spring axis B when the spring 9 is compressed.

Preferably, the webs 9B deform when the main spring 9 is compressed.

Preferably, an unwinding of a web 9B deformed by the compression of the main spring 9 is at least substantially sinusoidal or undulating, considering the center line of a web 9B.

In the following, further embodiments of the main spring 9 are explained with reference to the further figures, wherein the previous statements and explanations apply in particular accordingly or supplementarily, even if a repetition is omitted, and primarily only differences from the first embodiment are explained.

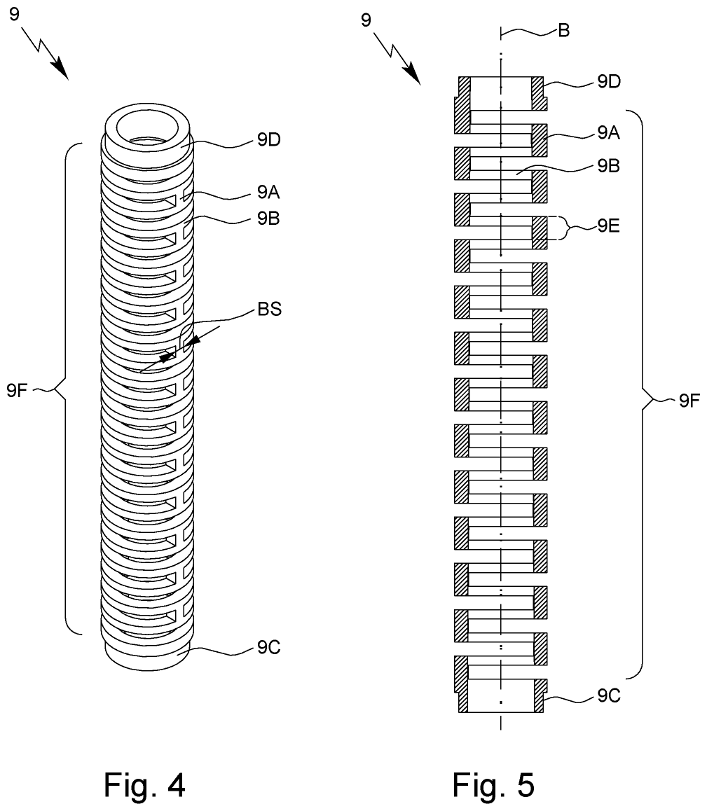

FIG. 4 shows a schematic representation of a second embodiment of a main spring 9 according to the proposal. FIG. 5 shows a schematic longitudinal section of the main spring 9 according to FIG. 4.

The second embodiment of the main spring 9 differs from the first embodiment in particular in that it has exactly one support 9A per spring layer 9E.

The supports 9A of two adjacent spring layers 9E are preferably rotated radially by 180° relative to each other.

Preferably, the spring axis B is bent in a zigzag pattern during compression of the main spring 9. Preferably, the microscopic bending of the spring axis B is averaged out from a macroscopic point of view.

Preferably, the supports 9A have a width BS.

The width BS is preferably greater than 0.5 mm, preferably greater than 1 mm, and/or less than 8 mm, preferably less than 5 mm.

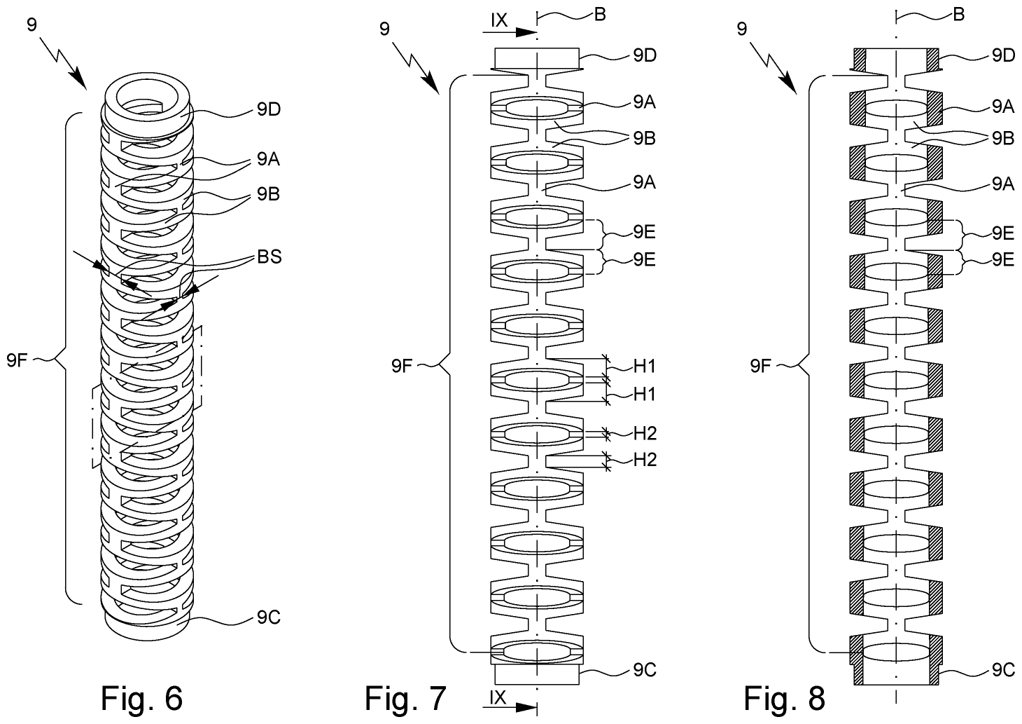

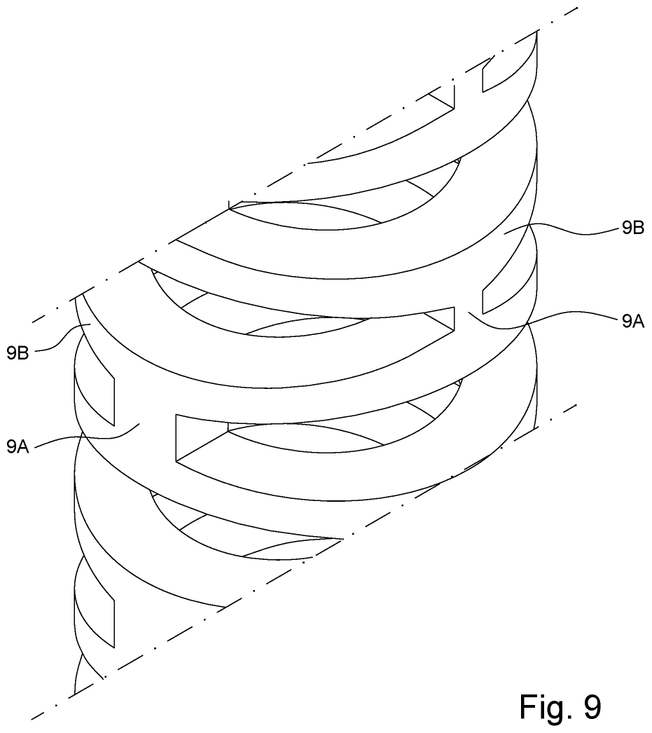

FIG. 6 shows a schematic representation of a third embodiment of a main spring 9 according to the proposal. FIG. 7 shows a schematic front view of the main spring 9 according to FIG. 6, FIG. 8 shows a longitudinal section of the main spring 9 according to FIG. 6, and FIG. 9 shows an enlarged section of the dash-dotted area of FIG. 6.

The main spring 9 of the third embodiment differs from the first two embodiments in particular in that its circumferential webs 9B change their axial height position and/or their axial thickness in the circumferential direction around the spring axis B.

By axial height position is preferably meant the axially highest point of a web 9B in an infinitesimal web section in the circumferential direction.

Preferably, the axial height position of a web 9B is at a maximum and/or minimum in the region where a support 9A is arranged in the direction of a carrier 9C, 9D.

Preferably, the axial thickness of a web 9B is at a maximum and/or minimum in a region in which a support 9A is arranged in the direction of a carrier 9C, 9D. Preferably, the axial thickness of a web 9B is at a minimum in a region that lies exactly between two regions of a web 9B with maximum axial thickness of the web 9B in the circumferential direction about the spring axis B.

Preferably, the progression of the axial thickness in a spring plane 9E from one of the supports 9A of the spring plane 9E to an adjacent support 9A of the spring plane 9E is: thick-thin-thick-thin-thick. In particular, the progression of the axial thickness in a spring plane 9E with two supports 9A is thick-thin-thick-thin-thick-thin-thick-thin, where the spring plane 9E merges back into itself after the last thin.

Preferably, the axial thickness of a web 9B is at a maximum in a region in which a support 9A is arranged above it and/or below it. Preferably, the axial thickness of a web 9B is at a minimum in a region that lies exactly between two regions of a web 9B with maximum axial thickness of the web 9B in the circumferential direction about the spring axis B.

Preferably, the height H1 of a web 9B is the axial distance from the lowest point of the web 9B to the highest point of the same web 9B.

Preferably, the widths BS of two supports 9A of two adjacent spring layers 9E are different. In particular, the width BS of the wider support 9A is more than 1.5 times the width BS of the narrower support 9A.

The cross-section of the webs 9B is preferably at least substantially trapezoidal.

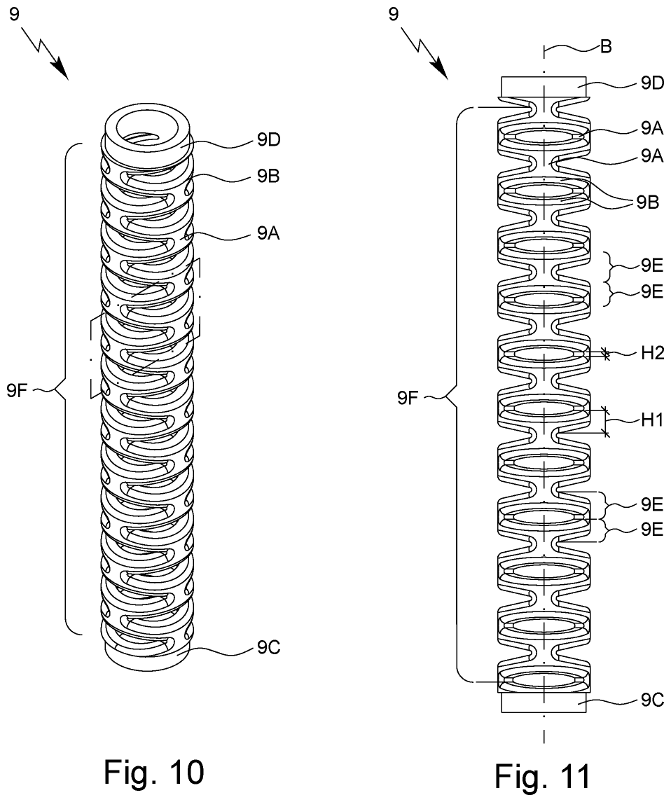

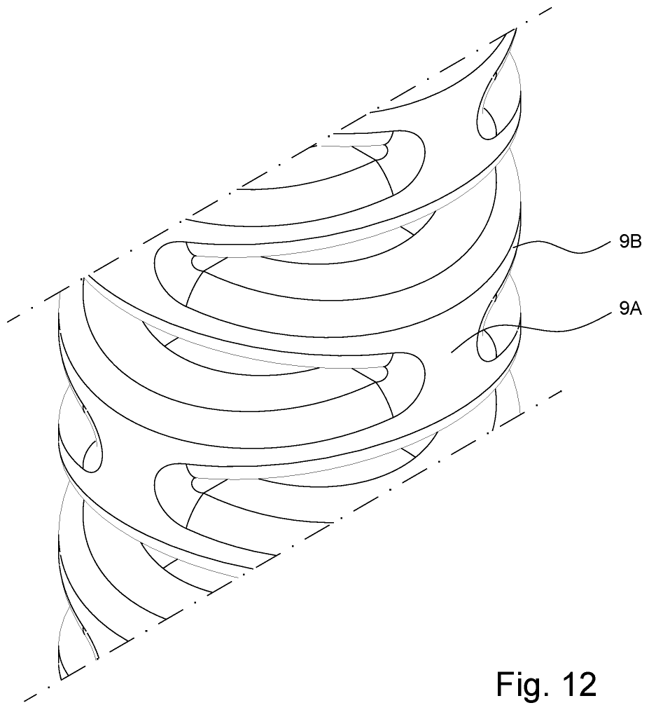

FIG. 10 shows a schematic representation of a fourth embodiment of a main spring 9 according to the proposal. FIG. 11 shows a schematic frontal view of the main spring 9 according to FIG. 10, and FIG. 12 shows an enlarged section of the dash-dotted area from FIG. 10.

The main spring 9 of the fourth embodiment differs from the first three embodiments in that the supports 9A merge into the webs 9B in a curved manner.

Preferably, a support 9A merges into a web 9B in a rounded manner with a radius of curvature.

Preferably, in a region where a support 9A and a web 9B are connected to each other, one, preferably several, in particular all, outer surfaces of a support 9A and/or a web 9B are curved.

An outer surface of a support 9A or a web 9B generally refers, in the present invention, to the region where no elements are disposed.

Preferably, the webs 9B and supports 9A each merge into each other with a radius of curvature greater than 1 mm.

Preferably, the curvature of a web 9B and/or a support 9A does not change its direction or sign.

Preferably, the cross-sectional area of a web 9B is at least substantially polygonal with chamfered and/or rounded corners, in particular with four, five, six, seven, eight, nine or ten corners.

Preferably, the cross-sectional area of a support 9A is rectangular.

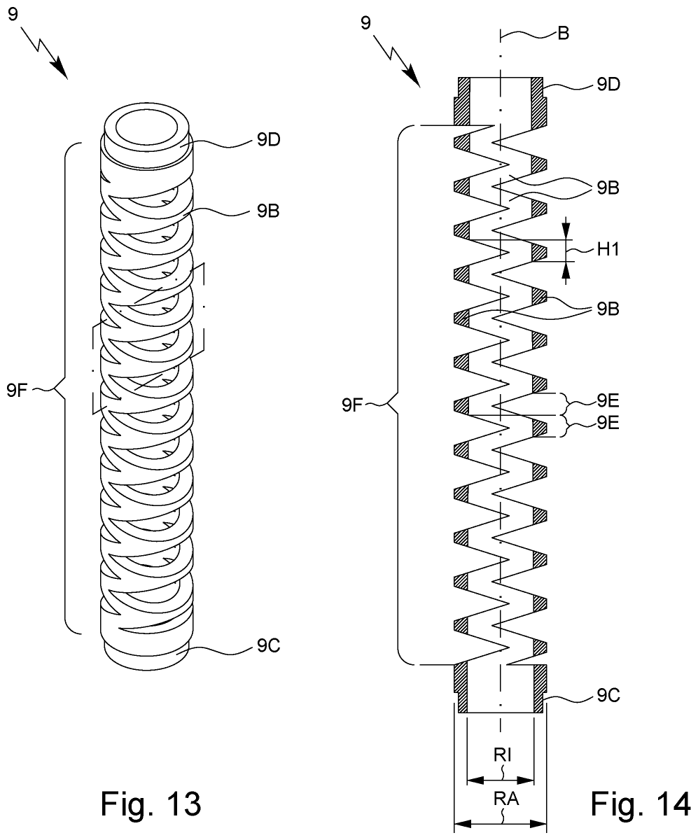

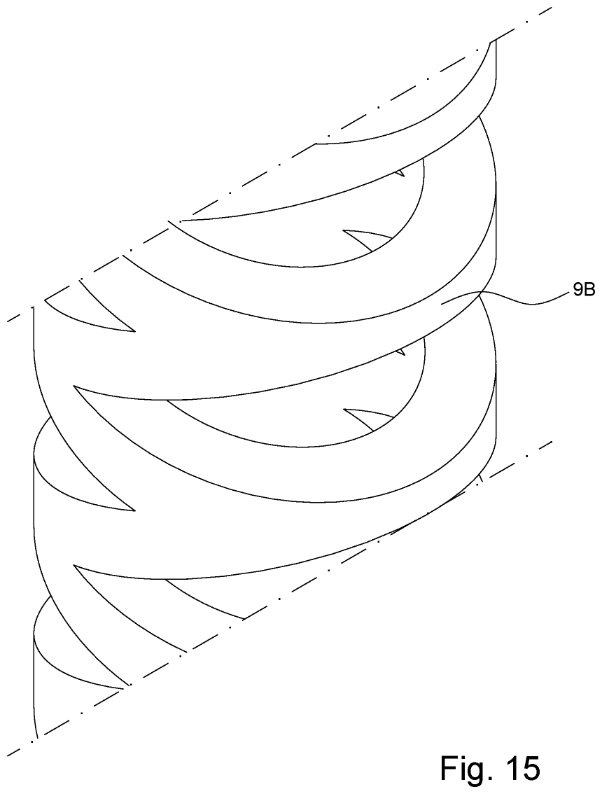

FIG. 13 shows a schematic representation of a fifth embodiment of a main spring 9 according to the proposal. FIG. 14 shows a schematic longitudinal section the main spring 9 according to FIG. 13, and FIG. 15 shows an enlarged section of the dash-dotted area from FIG. 13.

The fifth embodiment of the main spring 9 according to the proposal differs from the previous embodiments in that it does not have supports 9A, but is formed only from webs 9B.

Preferably, the webs 9B change their axial height position circumferentially around the spring axis B, preferably wherein there is a longitudinal section of the main spring 9, which in particular includes the spring axis B, in which the webs 9B run in a zigzag manner.

Preferably, one web 9B merges into an adjacent web 9B.

Preferably, a spring layer 9E is formed by a web 9B.

Preferably, the height H1 of a web 9B is identical to the height of a spring layer 9E.

Preferably, a main extension plane of a spring layer 9E is tilted with respect to a radial plane of the main spring 9, in particular by more than 5°, preferably more than 10°, and/or less than 40°, preferably less than 30°.

The axial thickness of a web 9B is preferably constant in the circumferential direction, although this does not apply to the areas where two webs 9B merge.

Preferably, the cross-sectional area of a web 9B is at least substantially trapezoidal.

Preferably, the height H1 of a web 9B is given by the axial distance between the two lowest points of two adjacent webs 9B. This is illustrated in FIG. 14, in which the distance between two cut surfaces of two adjacent spring layers 9E is determined, with the lowest point of a web 9B being considered in each case.

Preferably, the angle enclosed by two adjacent webs 9B is greater than 10°, preferably greater than 20°, and/or less than 60°, preferably less than 50°.

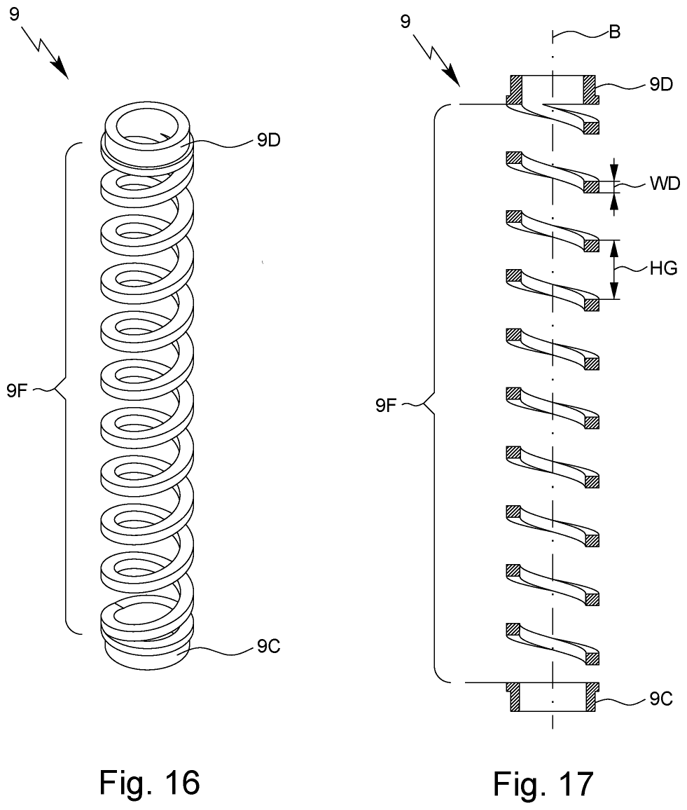

FIG. 16 shows a schematic representation of a sixth embodiment of a main spring 9 according to the proposal. FIG. 17 shows a schematic longitudinal section of the main spring 9 according to FIG. 16.

The sixth embodiment of the main spring 9 according to the proposal differs from the embodiments already described in that it is also formed only by webs 9B that change their axial height position in the circumferential direction, but one web 9B does not merge into itself after a complete revolution about the spring axis B, that is, after 360°.

For simplified description, the main spring 9 of the sixth embodiment is described as if it were a spiral spring. It is expressly noted that the main spring 9 of the sixth embodiment is not a coil spring, but is one formed of webs 9B that change their axial height position in the circumferential direction, with one web 9B not merging into itself after a complete revolution about the spring axis B, i.e. after 360°.

Preferably, the main spring 9 has a pitch angle, a winding thickness WD, a winding width WB and a pitch HG.

Preferably, the pitch HG is greater than the winding thickness WD.

Preferably, the winding thickness WD is greater than 0.5 mm, preferably greater than 1 mm and/or less than 5 mm, preferably less than 4 mm.

Preferably, the winding width WB is greater than 0.5 mm, preferably greater than 1 mm and/or less than 5 mm, preferably less than 4 mm.

Preferably, the pitch HG is greater than 2 mm, preferably greater than 3 mm and/or less than 20 mm, preferably less than 15 mm.

Preferably, the winding thickness WD is the axial height of a cross-sectional area of the spiral of the main spring 9, in this section.

Preferably, the cross-sectional area is rectangular, in particular square.

Preferably, the pitch angle—of the relaxed main spring 9—is greater than 5°, preferably greater than 10°, and/or less than 40°, preferably less than 35°.

The pitch angle is preferably the angle at which the spring winding rises.

Preferably, the pitch HG is the sum of the winding thickness WD and the minimum axial distance between two cross-sectional surfaces of the coil spring, in a front view of a section, the section plane containing the spring axis B.

In the following, the outlet spring 16 according to the proposal, which is already shown schematically in FIG. 1, is explained in more detail, wherein the previous explanations and aspects and features relating to the main spring 9 also apply correspondingly or supplementarily without repetition and, conversely, the following statements, explanations and features relating to the outlet spring 16 also apply correspondingly or supplementarily to the various embodiments of the main spring 9 and can be combined.

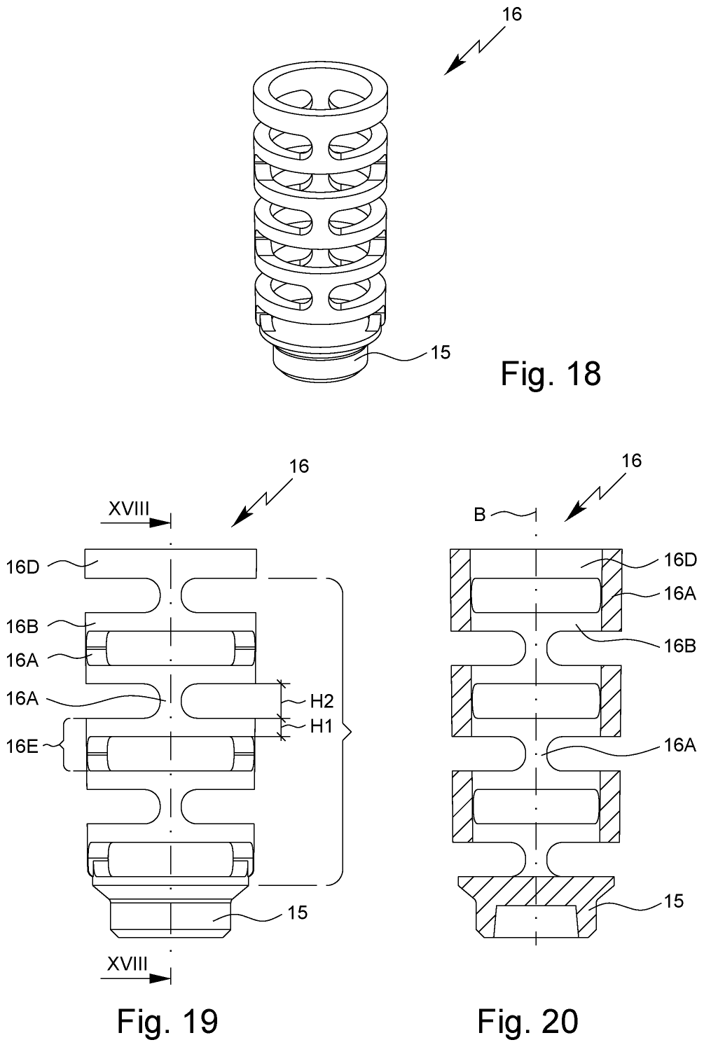

FIG. 18 shows a schematic view of the outlet spring 16 in the corresponding state. FIG. 19 shows a schematic front view of the outlet spring 16 according to FIG. 18 and FIG. 20 shows a schematic longitudinal section of the outlet spring 16 according to FIG. 18.

The characteristics described above also apply to the outlet spring 16.

Preferably, the outlet spring 16 has an outlet valve body 15, an upper carrier 16D, one or more webs 16B and/or one or more supports 16A and/or a spring axis B.

Preferably, the basic geometric body formed by the outlet spring 16 is at least substantially frustoconical.

Preferably, the angle between the spring axis B and the generatrix of a frustrum formed by the outlet spring 16 is greater than 1°, preferably greater than 1.5°, and/or less than 10°, preferably less than 5°.

In the relaxed state, the resilient section 16F preferably has a length L of more than 5 mm, preferably more than 10 mm and/or less than 50 mm, preferably less than 40 mm.

The resilient section 16F preferably has a length LV of more than 4 mm, preferably more than 8 mm, and/or less than 40 mm, preferably less than 32 mm, in the pretensioned and/or installed state.

Preferably, the resilient section 16F is compressed by more than 2%, preferably more than 3%, and/or less than 40%, preferably less than 35%, in the pretensioned and/or installed state.

The resilient section 16F preferably has a length LK of more than 3 mm, preferably more than 7 mm, and/or less than 35 mm, preferably less than 27 mm, in the maximum compressed state.

Preferably, the resilient section 16F is compressed by more than 3%, preferably more than 5%, and/or less than 60%, preferably less than 50%, in the maximum compressed state.

Preferably, the outlet spring 16 is dimensioned such that the outlet valve 14 remains closed during the (entire) movement of the pump piston 10 upwards and/or to the initial position and/or during the entire filling of the pump chamber.

Preferably, the outlet spring 16, like the main spring 9, is made of or consists of plastic, in particular a material mixture, especially preferably the same or a similar material as described below.

Experiments were carried out with the outlet spring 16 according to the proposal with regard to hysteresis, fatigue behavior, force-displacement diagram and compression. Accordingly, the features of the spring 9, 16 and/or material mixture(s) explained below are particularly preferred.

Preferably, the outlet spring 16 and/or the resilient section 16F is designed such that, at least up to a compression of 10%, the characteristic value K1 is less than 0.05 N/mm^{2.5}, in particular less than 0.025 N/mm^{2.5} and/or greater than 0.0005 N/mm^{2.5}, where K1=(W·L^{0.5})/(V·S²), where W is the work to compress the outlet spring 16 from the relaxed state by the path S, L is the length of the resilient section 16F in the relaxed state, and V is the plastic volume of the resilient section 16F. Experiments have surprisingly shown that a plastic spring formed in this manner has very good fatigue resistance and/or is at least substantially reversibly compressible.

Preferably, the characteristic value K1 applies alternatively or additionally to the main spring 9.

Preferably, the outlet spring 16 and/or the resilient section 16F, 16F is formed such that, at least up to a compression of 10%, the characteristic value K2 is smaller than 0.005 mm^{-3.5}, in particular smaller than 0.0025 mm^{-3.5} and/or greater than 0.00005 mm^{-3.5} where K2=(W·L^{0.5}·RA)/(V·AF·E·S²), where W is the work to compress the outlet spring 16 from the relaxed state by the path S, RA is the outer diameter of the resilient section 16F, AF is the filling factor of the relaxed resilient section 16F, E is the modulus of elasticity of the material of the resilient section 16F, and V is the plastic volume of the resilient section 16F. Experiments have unexpectedly shown that a plastic spring formed in this manner is at least substantially hysteresis-free and/or has at least substantially a linear force-displacement diagram.

Preferably, the characteristic value K2 applies alternatively or additionally to the main spring 9.

The following table shows the characteristic values K1 and K2 for an outlet spring 16 according to the invention and a main spring 9 according to the invention, and the parameters for calculating K1 and K2 determined by experiments. The main spring 9 is the first embodiment, wherein the characteristic values K1 and K2 preferably also apply to the other embodiments of the main spring 9. The springs 9 and 16 investigated were made of plastic, namely a material mixture containing 90% by weight propylene and 10% by weight polyethylene.

| | | Outlet | Main |
|---|---|---|---|
| | | spring 16 | spring 9 |
| Compression path | S [mm] | 3 | 5 |
| Force during | F [N] | 6 | 5.7 |
| compression by | | | |
| compression path | | | |
| Spring constant | D [N/mm] | 2 | 1.14 |
| Work | W [N · mm] | 9 | 14.25 |
| Length | L [mm] | 17 | 61 |
| Volume | V [mm³] | 540 | 620 |
| Outer diameter | RA [mm] | 14.8 | 14.8 |
| Filling factor | AF | 0.4 | 0.4 |
| Modulus of elasticity | EM [MPa] | 1345 | 1345 |
| Characteristic value | K1 [N/mm^{2.5}] | 0.0076354 | 0.0071804 |
| Characteristic value | K2 [mm^{-3.5}] | 0.000210 | 0.0001975 |

The work W was calculated by determining the path integral of the force along the compression path S.

Preferably, the plastic volume V of the resilient section 9F, 16F is calculated by integrating from the axial start of the resilient section 9F, 16F to the axial end of the resilient section 9F, 16F over the cross-sectional area (comprising material).

Preferably, the plastic volume V refers to the resilient section 9F in the relaxed state.

From the table and the following diagrams, it can be seen that springs 9, 16 that satisfy the characteristic values K1 and K2 are at least substantially hysteresis-free, are at least substantially reversibly compressible, and/or have good fatigue resistance to frequent compression and/or over time.

It can also be seen as verification of the characteristic values K1 and K2 that the differently designed springs 9, 16 have very similar characteristic values K1 and K2 (see table).

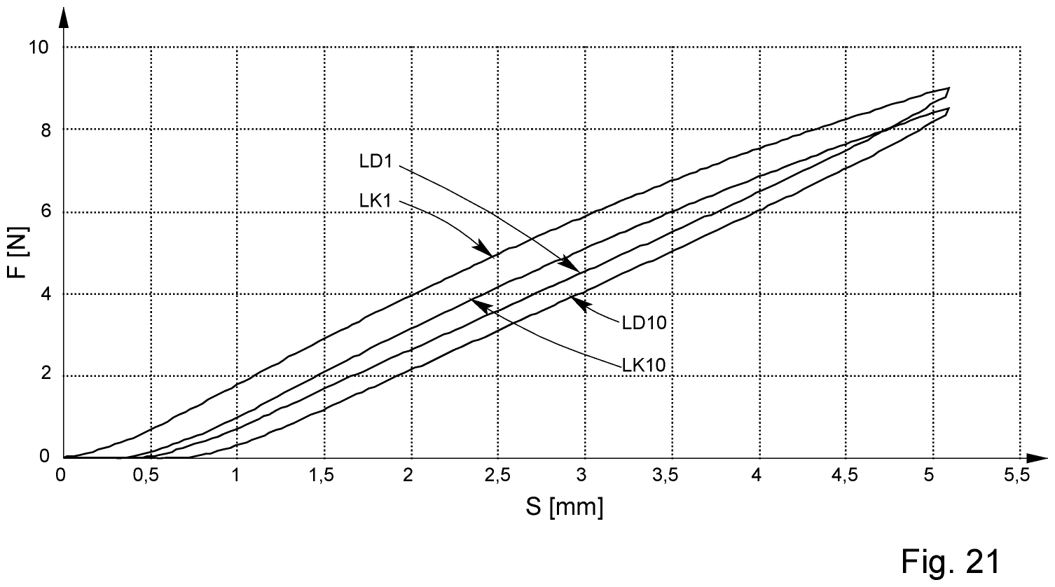

FIG. 21 is a force-displacement diagram of the outlet spring under study, showing the course of a first compression LK1 and first decompression LD1 and the tenth compression LK10 and tenth decompression LD10. On the x-axis the compression path S of the outlet spring 16 is shown and on the y-axis the restoring force F of the outlet spring 16 is shown as a function of the compression path S.

The test was carried out under application-realistic test conditions, namely at room temperature of about 20° ° C. to 25° C. and a humidity of 50%.

FIG. 21 shows that the restoring force at full compression drops from about 8.7 N to 8.3 N, i.e. only minimally between the first and tenth compression or actuation.

Preferably, the following parameters can be calculated from the diagram.

The work required for the first compression is 0.02175 J and the work required for the tenth compression is 0.02075 J.

The work released during the first decompression is 0.01985 J and the work released during the tenth decompression is 0.01900 J.

Consequently, the relative difference between the work required for the first/tenth compression and the work released during the first/tenth decompression is less than 30%.

Consequently, the spring is at least substantially hysteresis-free.

Furthermore, the relative difference between the work required for the first compression and the tenth compression is less than 25%. Consequently, the spring is at least substantially fatigue resistant.

The force-displacement diagrams are also fairly linear, so that the outlet spring 16 according to the invention has at least a substantially linear force-displacement diagram.

Furthermore, the diagram shows that the slope of a compression graph LK1, LK10 or decompression graph LD1, LD10 never changes by more than 30° during a compression or decompression.

Consequently, the outlet spring 16 is at least substantially hysteresis-free, at least substantially reversibly compressible, and exhibits good fatigue resistance to frequent compression.

Preferably, the characteristic values K1 and/or K2 apply to the outlet spring 16 and/or the main spring 9.

Preferably, the main spring 9 of the first to sixth embodiments is provided for use as a return element of a pump piston 10 and/or as an element of an inlet valve 11.

Preferably, the outlet spring 16 has a larger spring constant than the main spring 9.

Preferably, the outlet spring 16 is provided for use as or forms a valve body 15 of an outlet valve 14.

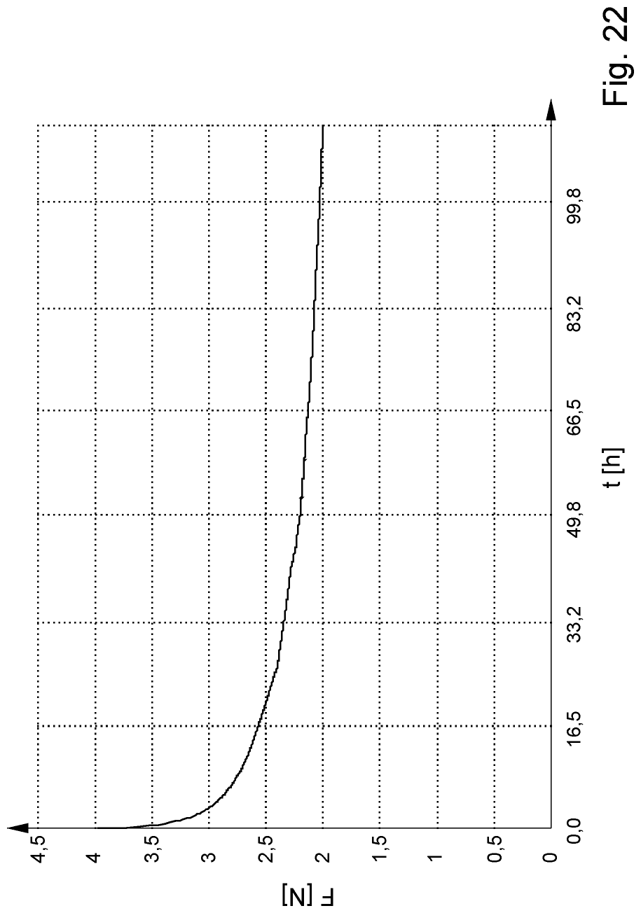

FIG. 22 shows in a diagram the variation over time and/or drop in the restoring force of the outlet spring 16, which is constantly pretensioned or compressed by 3 mm and whose characteristic values are listed in the preceding table.

The time in seconds is plotted on the x-axis and the restoring force F of the outlet spring 16 is plotted in Newton on the y-axis.

The experiment was carried out under application-realistic test conditions, as when determining the diagram according to FIG. 21 and carrying out the other experiments and measurements.

The diagram shows that the restoring force of the exhaust spring 16 initially decreases and then asymptotically approaches a limit value of about 50%. In particular, the restoring force of the exhaust spring 16 decreases by less than 50% within 100 h, here.

Here it can be seen that the discharge spring 16 has a relatively good fatigue resistance against a long lasting, constant compression. Accordingly, this results in a good stability and/or long shelf life of the compressed spring 9, 16 and/or dispensing apparatus 1 and/or pump 7.

The preceding and following explanations regarding the main spring 9 according to the proposal also apply accordingly to the outlet spring 16 according to the proposal and vice versa, as already mentioned, so that in the following reference is also generally made or referred only to the springs 9 and 16, respectively.

The spring 9 or 16 is made of or consists of plastic.

Preferably, the plastic is a material mixture. Preferably, the material mixture contains a basic component and an additional component.

Preferably, at least 50% by weight and/or at most 95% by weight, in particular at most 90% by weight, of the material mixture is formed from the basic component.

Preferably, the basic component is formed of or consists of polypropylene.

Preferably, the modulus of elasticity of the basic component is greater than 1000 MPa and/or the yield strength of the basic component until material fracture occurs is less than 1%.

Preferably, to determine the yield strength until material fracture occurs, a cylindrical bar of this material with a diameter of 1 cm and a length of 10 cm is pulled apart by forces acting at its axial ends along the longitudinal axis, and the relative change in length at material fracture defines the yield strength.

Preferably, the density of the additional component and/or material mixture is equal to or less than 0.9 g/cm³.

Preferably, the modulus of elasticity of the additional component is less than 1000 MPa and/or the yield strength of the additional component until material fracture occurs is less than 1%.

Preferably, the material mixture is formed from a thermoplastic and an elastomer.

Preferably, the additional component comprises or is selected from polyethylene, ethylene-octene copolymers as polyolefin elastomer, and/or isotactic propylene repeating units with random ethylene distribution as polyolefin elastomer.

Preferably, the modulus of elasticity of the material mixture is less than 1500 MPa.

Preferably, the modulus of elasticity of the material mixture is not linearly dependent on the proportion of the basic component or the proportion of the additional component.

Preferably, the materials of the material mixture, in particular before the spring 9, 16 is produced from the material mixture, are homogeneously physically mixed with each other, in particular by mechanical stirring.

Preferably, the spring 9, 16 is manufactured by injection molding. However, other manufacturing variants are also possible.

Preferably, the spring 9, 16 or the resilient section 9F, 16F is designed in such a way that it is free of undercuts on the injection mold side and/or from the outside, so that the injection molds can be removed after the plastic has solidified.

Preferably, the spring 9, 16 has a spring constant of less than 10 N/mm, preferably of less than 5 N/mm, particularly preferably of less than 2 N/mm.

Bionic measures are used to optimize the load absorption of the spring 9, 16. Preferably, the webs 9B, 16B and supports 9A, 16A each merge with a radius of curvature greater than 1 mm. In this way, it can be achieved that the load distribution within the spring 9, 16 is optimized. This prevents plastic deformation of the spring 9, 16 in these areas.

This was determined by finite element calculations. In particular, the spring 9, 16 can thus be designed to be very material-saving.

Optionally, the spring 9, 16 is plastically deformed during its first compression and is at least substantially reversibly compressible during subsequent compressions.

Preferably, the resilient section 9F, 16F of the spring 9, 16 has a filling factor of more than 30%, in particular more than 50% and/or less than 90%, in particular less than 80%.

In general, the filling factor in the present invention is the ratio of the volume of material to the ratio of the volume of the geometric shape formed by the resilient section 9F, 16F, for example, in the case of a hollow cylindrical spring 9, 16, the volume of material V of the resilient section 9F, 16F in relation to the volume of the hollow cylinder formed by the resilient section 9F, 16F.

Preferably, the spring 9, 16 is designed as a compression spring. In particular, therefore, it is preferably not stretched beyond its relaxed state when in use.

Preferably, the spring axis B of the spring 9, 16 is at least substantially maintained during compression, preferably whereby this is achieved by the shape of the spring 9, 16 and/or mutually cancelling curvatures or inclinations of the spring layers 9B during compression of the spring 9, 16 and/or an external curvature safety device of the spring 9, 16.

Preferably, the spring 9, 16 is in a pretensioned state when the dispensing apparatus 1 and/or pump 7 is in the initial state and/or the spring 9, 16 is permanently operated in a compressed state.

Preferably, at the beginning of the actuation of the dispensing apparatus 1 and/or pump 7 and/or in order to compress the main spring 9, which is pretensioned, in particular in the initial state of the dispensing apparatus 1 and/or pump 7, an initial actuating force F of less than 15 N, preferably less than 10 N, particularly preferably less than 5 N must be exerted on an actuating element and/or the dispensing head 4 of the dispensing apparatus 1 and/or pump and/or on the main spring 9.

Preferably, the actuating force to be exerted to reach the final state of the dispensing apparatus 1 and/or to reach the maximum compression of the main spring 9 is less than 50 N, preferably less than 35 N, particularly preferably less than 15 N.

Preferably, the ratio between the restoring force of the main spring 9 in the maximally compressed state or final state of the dispensing apparatus 1 and the restoring force of the main spring 9 in the pretensioned state or initial state of the dispensing apparatus 1 is less than 6, preferably less than 4.

Preferably, the difference between the restoring force of the spring 9, 16 in a maximally compressed state and the restoring force of the spring 9, 16 in a minimally compressed state is less than 20 N, preferably less than 15 N, particularly preferably less than 10 N.

Preferably, the spring 9, 16 can be compressed without torsion.

A possible torsion protection of the spring 9, 16 could be realized by guiding a radially protruding part of the spring 9, 16 in one or more recess(es) of the pump housing, which is/are preferably parallel to the spring axis B.

Preferably, the spring 9, 16 is formed integrally with other elements of the dispensing apparatus 1 and/or pump 7, such as the outlet valve body 15. This enables a simple, cost-effective and compact design of the dispensing apparatus 1 and/or pump 7.

The resilient section 9F preferably has a length LV of more than 15 mm, preferably more than 20 mm, and/or less than 90 mm, preferably less than 80 mm, in the pretensioned or installed state.

Preferably, the resilient section 9F is compressed by more than 2%, preferably more than 3% and/or less than 40%, preferably less than 35%, in the pretensioned or installed state.

The resilient section 9F preferably has a length LK of more than 13 mm, preferably more than 17 mm and/or less than 80 mm, preferably less than 70 mm, in the maximally compressed state.

Preferably, the resilient section 9F is compressed by more than 3%, preferably more than 5%, and/or less than 60%, preferably less than 50%, in the maximally compressed state.

The compression of the resilient section 9F is preferably given by (1−((L−S)/L)). 100%, where L is the length of the resilient section 9F in the relaxed state and S is the compression path of the resilient section 9F.

As mentioned above, a spring 9, 16 according to the invention is preferably at least substantially hysteresis-free, fatigue-resistant, reversibly compressible and/or a spring 9, 16 according to the invention preferably exhibits at least substantially a linear force-displacement diagram.

In the present invention, hysteresis of a spring 9, 16 means a difference between the compression behavior and the decompression behavior of a spring. In particular, in a spring 9, 16 having hysteresis, the work required to bring the spring 9 from a relaxed state to a compressed state is greater than the work released when the spring 9, 16 is decompressed from this state. In particular, in a force-displacement diagram of a spring 9 having hysteresis, the compression curve and the decompression curve do not overlap.

In an at least substantially hysteresis-free spring 9, 16, the relative difference between the work required to bring the spring 9 from a relaxed state to a compressed state and the work released when the spring 9, 16 is decompressed from this state is less than 30%, preferably less than 20%, particularly preferably less than 10%. In particular, the amount of hysteresis depends on the amount of compression of the spring 9, 16. A spring according to the invention is preferably free of hysteresis if the spring is compressed less than 20%, preferably less than 30%, particularly preferably less than 40%.

Preferably, a spring 9, 16 is fatigue resistant if it can be compressed more than 100 times, preferably more than 200 times, more preferably more than 500 times by less than 20%, preferably less than 30%, more preferably less than 40%, without reducing and/or increasing the spring constant of the spring 9, 16 by more than 30%. In particular, a spring 9, 16 is fatigue resistant if it can be compressed by less than 20% for more than 1000 hours, preferably more than 5000 hours, particularly preferably more than 20000 hours, without reducing the spring constant of the spring 9, 16 by more than 50%.

In the present invention, reversibly compressible generally means with respect to a spring 9, 16 that the spring 9, 16 has the same shape, relaxed length and/or spring constant before and after a compression. In particular, a spring 9, 16 is at least substantially reversibly compressible if the relaxed length and/or spring constant changes only by less than 35% as a result of a compression. In particular, a spring 9, 16 according to the invention is at least substantially reversibly compressible up to a compression of less than 20%, preferably of less than 30%, particularly preferably of less than 40%.

A spring 9, 16 has an at least substantially linear force-displacement diagram if the restoring force of the spring 9, 16 is at least substantially proportional to the compression path of the spring 9, 16. In particular, a force-displacement diagram is at least substantially linear if the slope of the graph in a force-displacement diagram changes by less than 30%. In particular, the force-displacement diagram of a spring 9, 16 according to the invention is at least substantially linear up to a compression of the spring 9, 16 of less than 20%, preferably of less than 30%, particularly preferably of less than 40%.

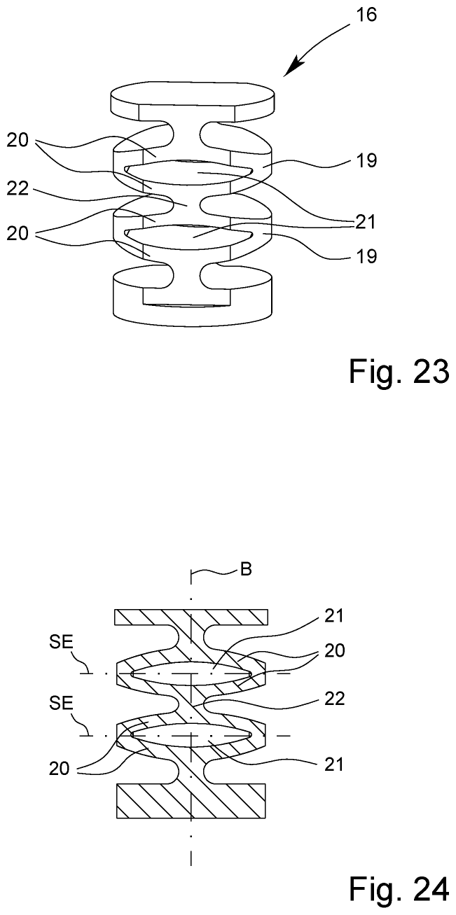

FIGS. 23 and 24 show a second embodiment of the outlet spring 16, which is described in more detail below. The preceding explanations relating to the outlet spring 16 preferably also apply to the second embodiment, unless explicitly explained otherwise or the preceding explanations are obviously incompatible with the following explanations.

The embodiment of the outlet spring 16 shown in FIGS. 23 and 24 differs from the embodiment of the outlet spring 16 shown in FIGS. 18 to 20 in particular by a different design of the spring elements, which in the embodiment of the outlet spring 16 shown in FIGS. 18 to 20 are preferably formed by the webs 16B and supports 16A.

In the embodiment shown in FIGS. 23 and 24, the outlet spring 16 preferably has a leaf spring-like or disc spring-like construction.

Preferably, the outlet spring 16 has at least one, preferably at least two or more, spring elements 19. The spring elements 19 are preferably arranged axially one behind the other.

The spring elements 19 are preferably of the same type, in particular identical.

A spring element 19 preferably has or is formed in each case by two sections 20 which are of the same kind, in particular identical and/or mirror images of one another. The sections 20 preferably extend essentially transversely to the spring axis B, in particular of the outlet spring 16. Preferably, the sections 20 are of planar design.

The spring elements 19 and/or sections 20 are preferably each made of plastic, in particular polyethylene (PE) and/or polypropylene (PP), and/or an elastic material.

Preferably, the sections 20 of a spring element 19 are each formed and/or arranged mirror-symmetrically to a mirror plane SE, preferably with the mirror plane SE extending transversely, in particular perpendicularly, to the spring axis B. This is shown in particular in FIG. 24.

The sections 20 are preferably bent or curved. In cross-section, as shown in particular in FIG. 24, the sections 20 preferably each form an arc curved away from a (hypothetical) plane arranged horizontally with respect to the spring axis B.

The two sections 20 of a spring element 19 are preferably bent or curved in opposite directions in each case, in particular curved in a single arc and/or in the manner of an arc of a circle, as shown in particular in FIGS. 23 and 24. Preferably, the sections 20 each have a simply curved surface and/or the sections 20 each represent a simply curved part. In particular, the two sections 20 of a spring element 19 are each curved away from the respective mirror plane SE, so that the distance between two sections 20 of a spring element 19 decreases as the distance from the spring axis B increases.

Preferably, the two sections 20 of a spring element 19 are connected to each other in a direction transverse, in particular perpendicular, to the spring axis B at their ends spaced from the spring axis B. The spring elements 19 are preferably ring-shaped.

The spring elements 19 are preferably compressible. Due to the curvature of the sections 20 in combination with the connected ends, spring elements 19 are formed in particular which have a free space 21 between the sections 20 in each case, which free space 21 extends essentially transversely to the spring axis B. The free space 21 is in particular mirror-symmetrical to the respective mirror plane SE of the spring element 19. Preferably, the free space 21 and/or distance between two sections 20 of a spring element 19 is greatest at the spring axis B and decreases with increasing distance from the spring axis B until the sections 20 meet at the ends.

Preferably, the free spaces 21 allow compression or upsetting of the outlet spring 16, in particular in combination with the plastic and/or elastic material of which the outlet spring 16 or the spring elements 19 or their sections 20 are made. During compression or upsetting, the sections 20 of a spring element 19 are preferably moved towards each other and/or the free space 21 of the spring element 19 is reduced.

Preferably, two adjacent spring elements 19 are each connected to each other by a connecting piece 22. The connecting piece 22 or the connecting pieces 22 is/are preferably made of the same material as the spring elements 19 and/or is/are preferably formed in one piece with the spring elements 19.

The connecting pieces 22 are preferably arranged centrally and/or in the area of the spring axis B.

Preferably, the connecting pieces 22 are elongated and/or linear and/or the connecting pieces extend transversely, in particular perpendicularly, to the spring axis B.

The sections 20 preferably each have an at least substantially constant thickness. The thickness of a section 20 is preferably at least 0.2 mm or more, preferably 0.4 mm or more, and/or at most 0.8 mm or less, preferably 0.6 mm or less, in particular about 0.5 mm.

The maximum distance between two sections 20 of a spring element 19 or the height of the free space 21 of a section, in particular in the center or along the spring axis B and/or perpendicular to the mirror plane SE, is preferably at least 0.75 mm or more, preferably 0.85 mm or more, and/or at most 1.15 mm or less, preferably 1.05 mm or less, in particular about 0.95 mm.

The width of a free space 21, in particular thus the extent of a clearance perpendicular to the spring axis B and/or parallel to and/or in the mirror plane SE is preferably at least 3.0 mm or more, preferably 3.5 mm or more, and/or at most 5.0 mm or less, preferably 4.5 mm or less, in particular about 3.9 mm.

The width of a connecting piece 22 is preferably at least 0.6 mm or more, preferably 0.7 mm or more, and/or at most 1.0 mm or less, preferably 0.9 mm or less, in particular about 0.8 mm.

Individual aspects and features of the present invention can be implemented independently, but also in any combination and/or sequence.

List of reference signs:

| | |
|---|---|
| 1 | Dispensing apparatus |
| 2 | Product/Fluid |
| 3 | Container |
| 4 | Dispensing head |
| 4A | Nozzle |
| 5 | Connecting part |
| 6 | Housing part |
| 6A | stop |
| 7 | Pump |
| 7A | Pump chamber |
| 8 | Pump housing |
| 9 | Main spring |
| 9A | Support |
| 9B | Web |
| 9C | Lower carrier |
| 9D | Upper carrier |
| 9E | Spring layer |
| 9F | Resilient section |
| 10 | Pump piston |
| 10A | Shaft/section |
| 11 | Inlet valve |
| 12 | Inlet valve body |
| 13 | Inlet valve seat |
| 14 | Outlet valve |
| 15 | Outlet valve body |
| 16 | Outlet spring |
| 16A | Support |
| 16B | Web |
| 16D | upper carrier |
| 16E | Spring layer |
| 16F | Resilient section |
| 17 | Riser |
| 18 | Outlet valve seat |
| 19 | Spring element |
| 20 | Section |
| 21 | Free space |
| 22 | Connecting piece |
| A | Longitudinal axis |
| B | Spring axis |
| BS | Width support |
| HG | Pitch |
| H1 | Height web |
| H2 | Height support |
| L | Relaxed spring length |
| LK | Minimum spring length |
| LV | Pretensioned spring length |
| RI | Spring inner diameter |
| RA | Spring outer diameter |
| S | Compression path |
| SE | Mirror plane |
| V | Plastic volume |
| WB | Winding width |
| WD | Winding thickness |

1-19. (canceled)

20. A dispensing apparatus comprising a spring made of plastic,
the spring having a resilient section which has a length L in the relaxed state,
wherein the resilient section is reversibly compressible by at least 10% and the modulus of elasticity of the plastic is less than 1500 MPa, and
wherein the spring has a spring constant of less than 10 N/mm.

21. The dispensing apparatus according to claim 20, wherein the resilient section has a filling factor of more than 15% and/or less than 90% and/or comprises at least substantially circumferentially extending webs and at least substantially axially extending supports.

22. The dispensing apparatus according to claim 20, wherein the ratio of the length L of the resilient section to the outer diameter RA of the resilient section is greater than 5.

23. The dispensing apparatus according to claim 20, wherein the spring forms a valve element of an inlet or outlet valve.

24. The dispensing apparatus according to claim 20, wherein the resilient section is at least essentially hollow cylindrical.

25. A dispensing apparatus comprising a spring made of plastic,
the spring having a resilient section which has a length L in the relaxed state,
wherein the plastic is a material mixture with polypropylene as the basic component and at least one additional component, and
wherein the density of the plastic is equal to or less than 0.9 g/cm3, and/or
wherein the density of the additional component is less than the density of the basic component, and/or
wherein the modulus of elasticity of the plastic is less than 1500 MPa.

26. The dispensing apparatus according to claim 25, wherein the additional component comprises or consists of polyethylene, ethylene-octene copolymers and/or isotactic propylene repeating units with random ethylene distribution.

27. The dispensing apparatus according to claim 25, wherein the modulus of elasticity of the additional component is less than 1000 MPa and/or wherein the modulus of elasticity of the basic component is greater than 1000 MPa.

28. The dispensing apparatus according to claim 25, wherein at least 50% by weight and at most 95% by weight of the material mixture is formed from the basic component.

29. The dispensing apparatus according to claim 25, wherein the resilient section is at least essentially hollow cylindrical.

30. A dispensing apparatus comprising a spring made of plastic,
the spring having a resilient section which has a length L in the relaxed state,
wherein at least one of:
the spring is designed such that, at least up to a compression of 10%, a characteristic value K1 is less than 0.05 [N/mm2.5], where K1=(W·L0.5)/(V·S²), where W is the work to compress the spring from the relaxed state by the path S, and V is the plastic volume of the resilient section, and
the spring is designed such that at least up to a compression of 10% a characteristic value K2 is smaller than 0.005 [mm-3.5], where K2=(W·L0.5·RA)/(V·AF·E·S²), where W is the work to compress the spring from the relaxed state by the path S, RA is the outer diameter of the resilient section, AF is the filling factor of the relaxed resilient section, E is the modulus of elasticity of the material of the resilient section and V is the plastic volume of the resilient section.

31. The dispensing apparatus according to claim 30, wherein the spring has a spring constant of less than 10 N/mm.

32. The dispensing apparatus according to claim 30, wherein the resilient section has a filling factor of more than 15% and/or less than 90%.

33. The dispensing apparatus according to claim 30, wherein the resilient section comprises at least substantially circumferentially extending webs and at least substantially axially extending supports.

34. The dispensing apparatus according to claim 33, wherein the webs and/or supports are arranged rotationally symmetrical to the spring axis of the resilient section and/or inversion symmetrical to the center of the resilient section and/or mirror symmetrical to a plane containing the spring axis of the resilient section.

35. The dispensing apparatus according to claim 33, wherein the ratio of the axial height H2 of a support to the axial height H1 of a web is greater than 1.2.

36. The dispensing apparatus according to claim 33, wherein the webs and supports merge into one another with a radius of curvature greater than 1 mm in each case.

37. The dispensing apparatus according to claim 30, wherein the ratio of the length L of the resilient section to the outer diameter RA of the resilient section is greater than 5 and/or the ratio of the outer diameter RA of the resilient section to the inner diameter RI of the resilient section is greater than 1.2.

38. The dispensing apparatus according to claim 30, wherein the spring forms a valve element of an inlet or outlet valve.

39. The dispensing apparatus according to claim 30, wherein the resilient section is at least essentially hollow cylindrical.
